(19) United States
(12) Patent Application Publication
(10) Pub. No.: US 2011/0210467 A1
(43) Pub. Date: Sep. 1, 2011

(54) METHODS FOR MAKING BOARD FOR HAIR CLIP

(76) Inventor: Yuan-Ming Tu, Tainan City (TW)

(21) Appl. No.: 12/714,509

(22) Filed: Feb. 28, 2010

(51) Int. Cl. B29C 45/14

(52) U.S. Cl. 264/132; 264/257; 264/279

(57) ABSTRACT

A method for making a board for a hair clip includes preparing a substrate and a patterned cloth layer. The substrate is made of plastic or metal. The patterned cloth layer is bendable cloth and includes a face with a pattern. The patterned cloth layer is bonded to a surface of the substrate. The substrate with the patterned cloth layer is placed in a mold. A transparent, plastic, outer layer is formed on the substrate by injection molding to cover the patterned cloth layer, obtaining a board for a hair clip. In another method, a substrate made of plastic or metal is prepared. A pattern layer is formed on a face of the substrate. The substrate with the pattern layer is placed in a mold. A transparent, plastic, outer layer is formed on the substrate by injection molding to cover the pattern layer, obtaining a board for a hair clip.

### BACKGROUND OF THE INVENTION

1. Field of the Invention

The present invention relates to methods for making a board for a hair clip and, more particularly, to methods for making a board for a hair clip with a higher yield while preventing fading of a pattern layer on the board.

2. Description of the Related Art

Conventional hair clips generally include a board that is subjected to surface treatment such as spray printing, baking varnish, transfer printing, gold tooling, etc. to provide a visual appealing effect. Also, a pattern layer may be formed after surface treatment to enhance ornamentation. However, the pattern layer is liable to fade and/or peel, adversely affecting the appearance. Furthermore, it is difficult to carry out transfer printing on an uneven face of the board of a hair clip, and the result is poor.

To avoid the above problems, an ornament plate or a cloth is fixed by bonding or other ways to a face of a board to enhance the visual pleasing effect. However, the assembling procedure becomes complicated, and the cost is increased. Furthermore, the ornament plate or cloth is liable to fade and/or peel due to touch or impact.

In another approach, the board is made of acrylic and includes a cloth layer between two boards. The boards take shape after pressing, and lugs are bonded to the boards to provide a pivotal portion for assembly with a pivot so as to form a hair clip. Large pressing force is required for making acrylic boards with a large curvature. Although the acrylic boards are covered by the cloth layer, the acrylic boards are liable to break due to large pressing force, leading to limitation to the curvature of the board. Furthermore, bonding of the lugs to improper positions of the boards results in non-smooth opening/closing of the hair clip. Furthermore, bonding is not reliable, leading to a low yield.

Thus, a need exists for methods for making a board for a hair clip with a higher yield while preventing fading of a pattern layer on the board.

### BRIEF SUMMARY OF THE INVENTION

The present invention solves this need and other problems in the field of low yield of hair clips by providing, in a first aspect, a method for making a board for a hair clip including preparing a substrate and a patterned cloth layer. The substrate is made of plastic or metal. The patterned cloth layer is bendable cloth and includes a face with a pattern. The patterned cloth layer is bonded to a surface of the substrate. The substrate with the patterned cloth layer is placed in a mold. A transparent, plastic, outer layer is formed on the substrate by injection molding to cover the patterned cloth layer, obtaining a board for a hair clip.

According to a second aspect of the present invention, a substrate made of plastic or metal is prepared. A pattern layer is formed on a face of the substrate. The substrate with the pattern layer is placed in a mold. A transparent, plastic, outer layer is formed on the substrate by injection molding to cover the pattern layer, obtaining a board for a hair clip.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a block diagram illustrating a method for making a board for a hair clip according to the preferred teachings of the present invention.

FIG. 2 shows a block diagram illustrating another method for making a board for a hair clip according to the preferred teachings of the present invention.

FIG. 3 shows an exploded, perspective view of a substrate and a patterned cloth layer of a first example of according to the preferred teachings of the present invention.

FIG. 4 shows a perspective view of the substrate and the patterned cloth layer of FIG. 3 with the patterned cloth layer bonded to the substrate.

FIG. 5 shows a perspective view of a board including an outer layer, the substrate, and the patterned cloth layer of the first example according to the preferred teachings of the present invention.

FIG. 6 shows a cross sectional view of the board of FIG. 5 according to section line A-A of FIG. 5.

FIG. 7 shows a perspective view of a hair clip including the board of FIG. 5.

FIG. 8 shows a substrate of a second example according to the preferred teachings of the present invention.

FIG. 9 shows a perspective view of a substrate of FIG. 8 with a pattern layer formed on a face of the substrate.

FIG. 10 shows an exploded, perspective view of a hair clip of the second example according to the preferred teachings of the present invention.

FIG. 11 shows a partial, cross sectional view of the hair clip of FIG. 10.

FIG. 12 shows a perspective view of the hair clip of FIG. 10.

FIG. 13 shows a perspective view of a hair clip of a third example according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

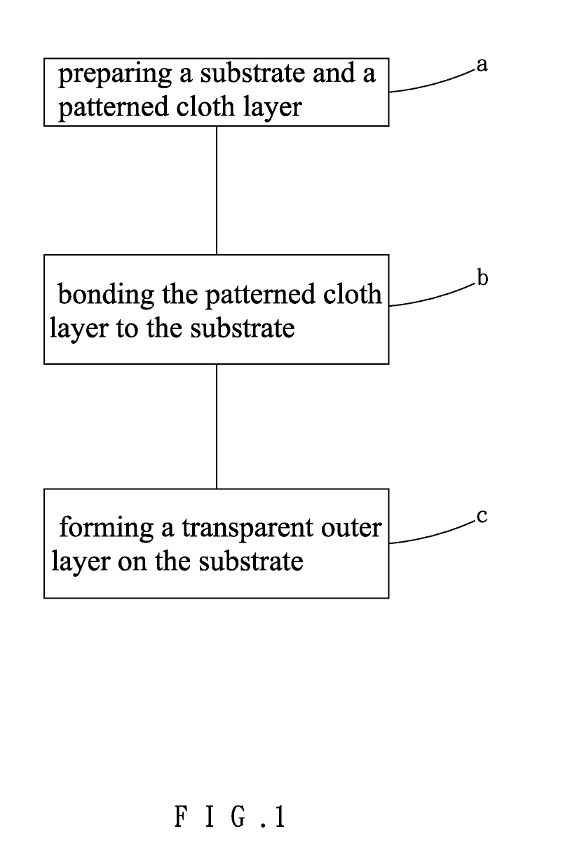

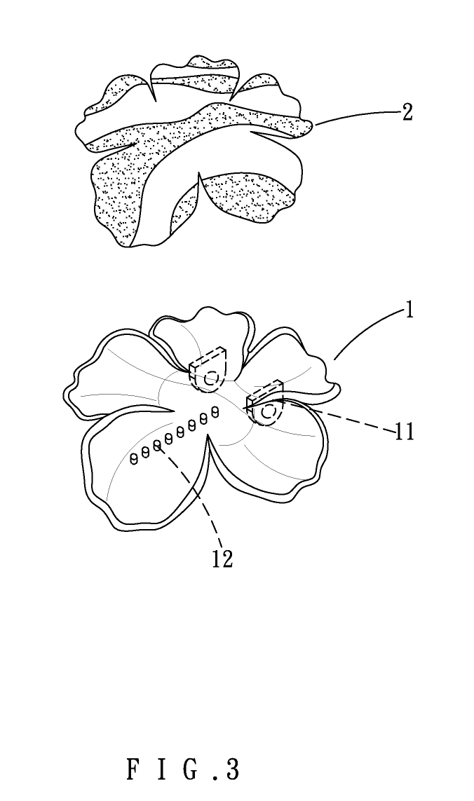

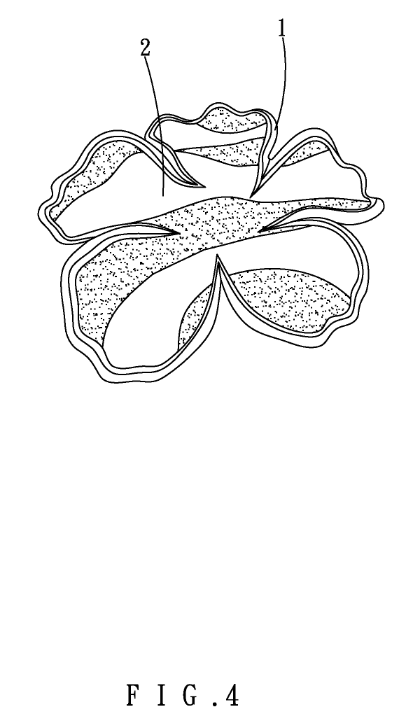

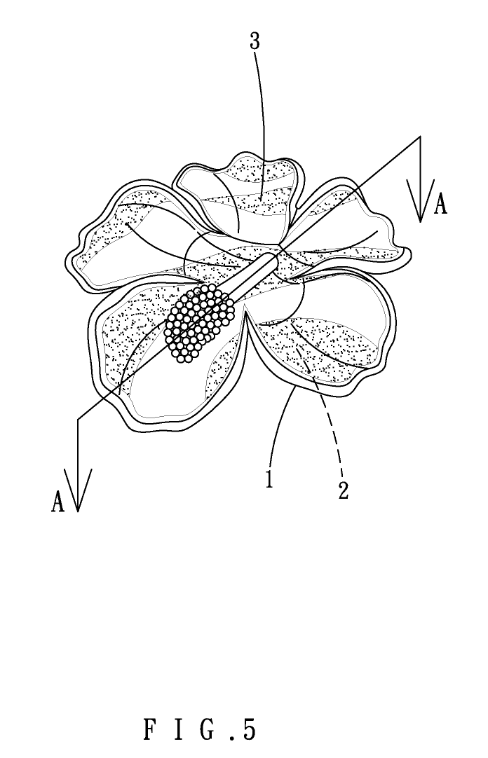

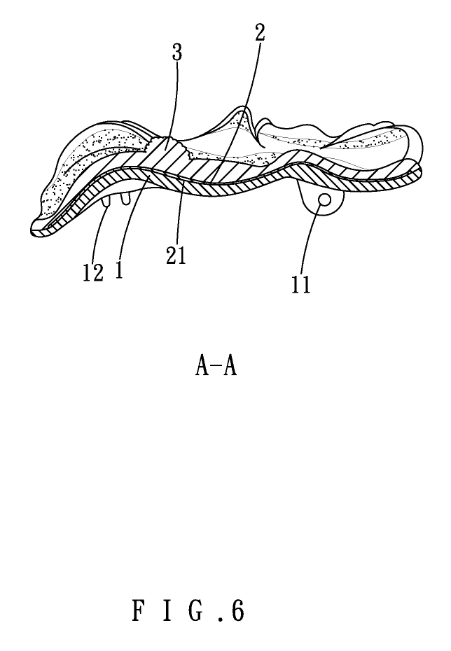

With reference to FIGS. 1 and 3-6, a method for making a board for a hair clip according to the preferred teachings of the present invention includes preparing a substrate 1 and a patterned cloth layer 2 (step a). The substrate 1 is made of plastic, metal, or other material and has a desired curvature. The substrate 1 has a shape corresponding to the board to be made. However, the substrate 1 has a shape corresponding to a portion of the board to be made. The substrate 1 includes a pivotal portion 11 and a plurality of teeth 12. The patterned cloth layer 2 is bendable cloth and includes a face with a pattern. The patterned cloth layer 2 is bonded to a surface of the substrate 1 (step b). It can be appreciated that the patterned cloth layer 2 is bonded to the surface opposite to the pivotal portion 11 and the teeth 12. Next, the substrate 1 with the patterned cloth layer 2 is placed in a mold. A transparent, plastic, outer layer 3 is formed on the substrate 1 by injection molding to cover the patterned cloth layer 2 (step c). A board for a hair clip is, thus, obtained. It can be appreciated that the patterned cloth layer 2 is sandwiched between the substrate 1 and the outer layer 3. The shape of the outer layer 3 does not have to correspond to the substrate 1. In the preferred form shown in FIG. 6, the outer layer 3 is in the shape of a flower.

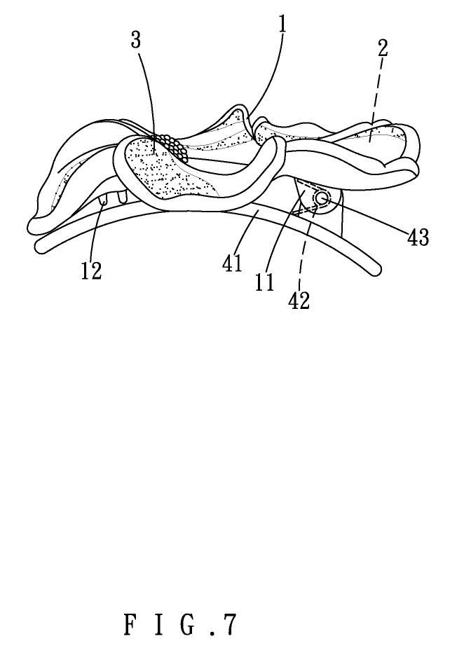

With reference to FIG. 7, the board can be assembled with a clamp 41, a spring 42, and a pivot 43 to form a hair clip. The patterned cloth layer 2 is soft and, thus, can be bonded to the face of the substrate 1 while matching with the curvature of the substrate 1. Furthermore, the patterned cloth layer 2 is covered by the outer layer 3 and, thus, prevented from fading and peeling due to touch and impact to the patterned cloth layer 2, prolonging the service life of the hair clip. Namely, the hair clip can still provide a visually appealing effect after having been used a longer period of time. Furthermore, the patterned cloth layer 2 can be viewed through the transparent outer layer 3, which is visually appealing.

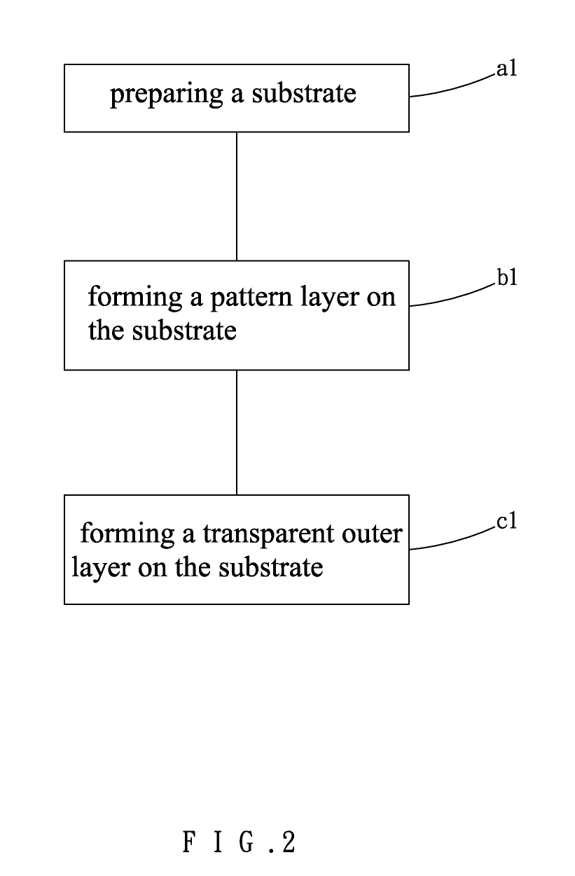

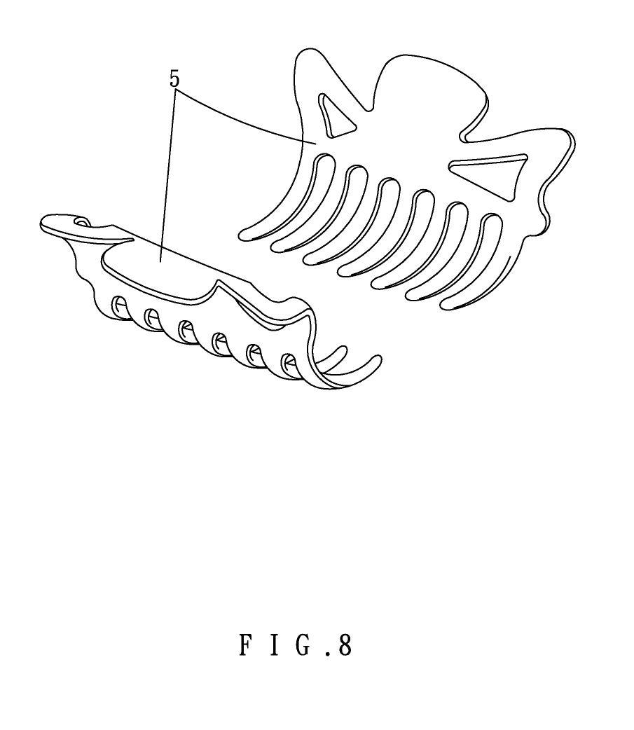

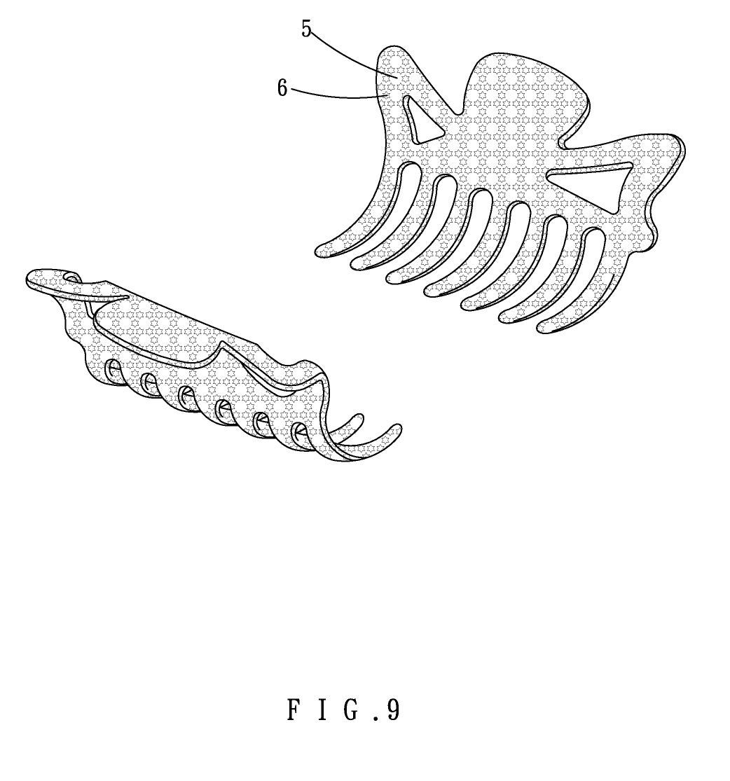

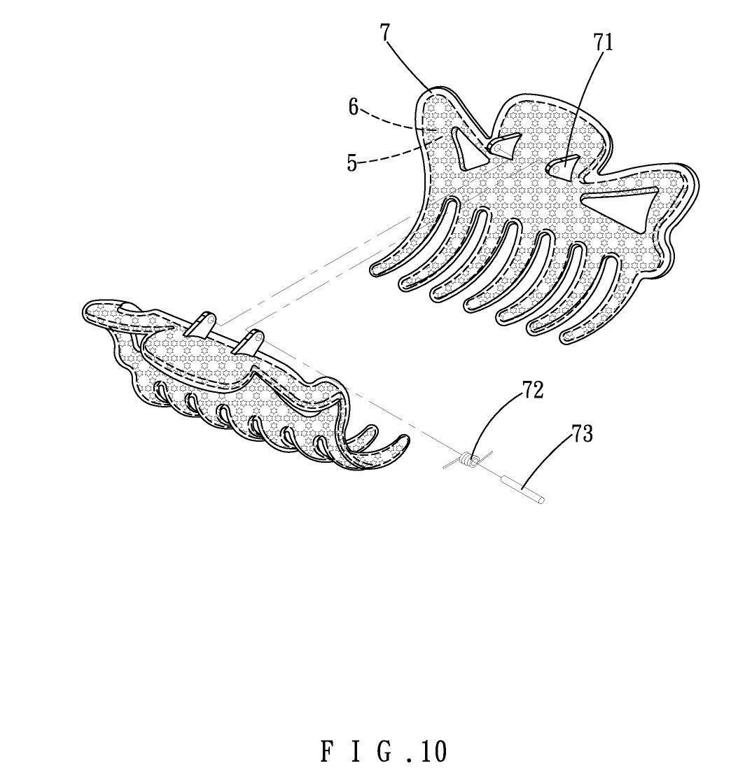

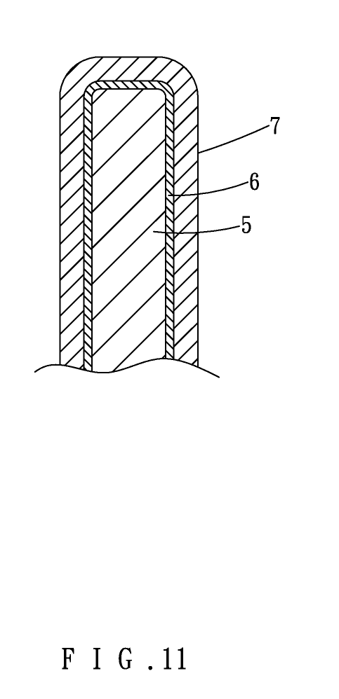

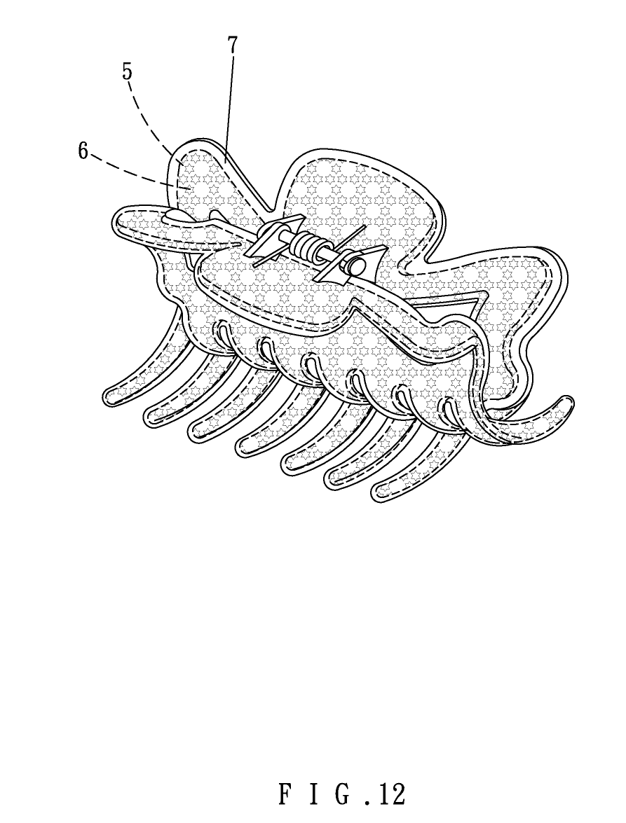

With reference to FIGS. 2 and 8-12, another method for making a board for a hair clip according to the preferred teachings of the present invention includes preparing a substrate 5 made of plastic or metal (step a1). In the preferred form shown, the substrate 5 includes two half pieces. The substrate 5 has a size corresponding to the board to be made. However, the substrate 5 can have a size corresponding to a portion of the board to be made. The substrate 5 has a flat face. A pattern layer 6 is formed on the flat face of the substrate 5 by transfer printing, spray painting, baking varnish, or gold tooling (step b1). Since the face of the substrate 5 is flat, the pattern layer 6 can be formed throughout the whole face of the substrate 5. Next, the substrate 5 with the pattern layer 6 is placed in a mold. A transparent, plastic, outer layer 7 is formed on the substrate 5 by injection molding to cover the pattern layer 6 (step c1). The pattern layer 6 is sandwiched between the substrate 5 and the outer layer 7. A board for a hair clip is, thus, obtained. A pivotal portion 71 including a pair of lugs is formed on an inner side of each half piece. A spring 72 and a pivot 73 can be assembled with the board to form a hair clip. Since the pivotal portion 71 does not include any pattern, the visual effect of the hair clip is not adversely affected. The hair clip of the second example prevents fading and peeling while providing a visually appealing effect.

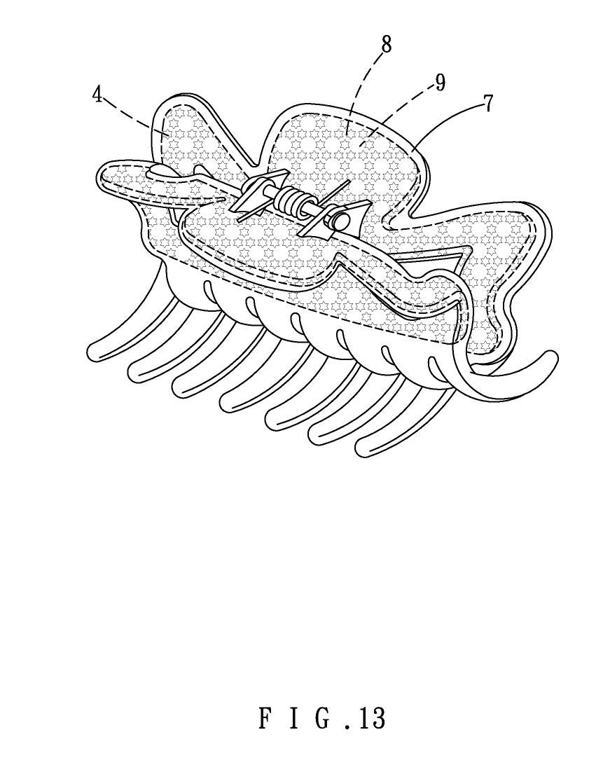

FIG. 13 shows a hair clip of a third example according to the preferred teachings of the present invention. The substrate 8 of the third example has a shape corresponding to a portion of the board. The outer layer 7 has an area the same as the board. Further, the shape of the substrate 8 and the pattern layer 9 provide a different visual effect.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A method for making a board for a hair clip comprising:
preparing a substrate and a patterned cloth layer, with the substrate being made of plastic or metal, with the patterned cloth layer being bendable cloth and including a face with a pattern;
bonding the patterned cloth layer to a surface of the substrate; and
placing the substrate with the patterned cloth layer in a mold and forming a transparent, plastic, outer layer on the substrate by injection molding, with the outer layer covering the patterned cloth layer, obtaining a board for a hair clip.

2. The method as claimed in claim 1, further including: forming a pivotal portion on the outer layer or the substrate.

3. The method as claimed in claim 3, with the substrate having a shape corresponding to the board.

4. The method as claimed in claim 1, with the substrate having a shape corresponding to a portion of the board.

5. A method for making a board for a hair clip comprising:
preparing a substrate made of plastic or metal;
forming a pattern layer on a face of the substrate; and
placing the substrate with the pattern layer in a mold and forming a transparent, plastic, outer layer on the substrate by injection molding, with the outer layer covering the pattern layer, obtaining a board for a hair clip.

6. The method as claimed in claim 5, with forming the pattern layer including forming the pattern layer on the face of the substrate by transfer printing, spray painting, baking varnish, or gold tooling.

7. The method as claimed in claim 5, with the substrate having a shape corresponding to the board.

8. The method as claimed in claim 5, with the substrate having a shape corresponding to a portion of the board.

9. The method as claimed in claim 5, further including: forming a pivotal portion on the outer layer or the substrate.
